(19) United States
(12) Patent Application Publication
(10) Pub. No.: US 2012/0033135 A1
(43) Pub. Date: Feb. 9, 2012

(54) Method and Apparatus For Listening to audio Corresponding to a PIP Display

(75) Inventor: Thomas Spinelli, Northport, NY (US)

(73) Assignee: Omnitek Partners LLC, Ronkonkoma, NY (US)

(21) Appl. No.: 13/277,183

(22) Filed: Oct. 19, 2011

Related U.S. Application Data
(63) Continuation of application No. 10/407,628, filed on Apr. 4, 2003.

(51) Int. Cl. H04N 5/45

(52) U.S. Cl. 348/565; 348/E05.112

(57) ABSTRACT

A method for enabling two or more viewers to simultaneously view and listen to different video content, the method including: displaying simultaneously video content from each of two or more tuners on a television monitor; producing with a speaker hardwired to the television monitor audio corresponding to the displayed video content from any of the two or more tuners; generating wireless audio signals corresponding to the displayed video content from any other of the two or more tuners simultaneously with the at least one speaker producing the audio; transmitting the wireless audio signals to a single remote control; receiving the wireless audio signals at the single remote control; directing the audio signals to headphones detachably connected to the remote control; and entering commands on the single remote control for controlling at least a changing of video content displayed and changing of an audio volume corresponding to the displayed video content.

### CROSS-REFERENCE TO RELATED APPLICATION

This application is a continuation application of U.S. application Ser. No. 10/407,628 filed on Apr. 4, 2003, the entire contents of which is incorporated herein by reference.

### BACKGROUND OF THE INVENTION

1. Field of the Invention

The present invention relates generally to television monitors having a picture-in-picture (PIP) display, and more particularly, to apparatus and methods for listening to audio corresponding to a PIP display. For purposes of this disclosure any television or other type of monitor that displays more than one video content at the same time is referred to herein as a PIP display even though the video content may be displayed in a split screen format.

2. Prior Art

Televisions are known in the art to display more than one video content or picture simultaneously. Such a capability is referred to PIP or picture-in-picture. A PIP capable television can display a second picture inside the boundaries of a first picture, such as in a corner. Alternatively, a PIP capable television can display first and second pictures side by side. Generally one of the picture displays is smaller in size than the other picture display, however, they may also be substantially the same size.

Although two pictures can be displayed simultaneously, generally only the audio portion of one of the pictures is reproduced on the speakers of the television. It is known in the art to have a headphone jack built-in to the monitor for using headphones to listen to the other of the picture displays. It is also known in the art to have a wireless headphone system built into the PIP capable television where a user listens to the other picture with wireless headphones which receives a wireless signal from the PIP capable television corresponding to an audio channel for the other of the pictures.

Although such systems allow two different users to simultaneously view and listen to two different pictures, they are not without disadvantages. For instance, wireless headphones are very costly. Where a headphone jack is supplied, a user uses relatively inexpensive headphones to listen to the other picture but is confined to remain near the television or have a long extension on the headphones that are being used.

### SUMMARY OF THE INVENTION

Therefore it is an object of the present invention to provide apparatus and methods for allowing more than one user to simultaneously view and listen to more than one picture (video content) on a PIP capable television (or other monitor) while avoiding the disadvantages associated with the prior art.

Accordingly, An apparatus for allowing two or more viewers to simultaneously view and listen to different video content is provided. The apparatus comprising: a monitor comprising: two or more tuners; a display for displaying video content from each of the two or more tuners; at least one speaker for producing audio corresponding to the display from one of the two or more tuners; and a wireless signal generation means for generating wireless audio signals corresponding to the display from another of the two or more tuners and for transmitting the wireless audio signals; and a remote control for use with the monitor, the remote control comprising: wireless signal receiving means for receiving the wireless audio signals from the wireless signal generation means and converting the wireless audio signals to audio signals; and a headphone connector operatively connected to the wireless signal receiving means for directing the audio signals to a headphones connected to the headphone connector.

Preferably, the monitor is a television. Preferably, the headphone connector is a female headphone jack disposed in the remote control.

Also provided is an apparatus for allowing two or more viewers to simultaneously view and listen to different video content. The apparatus comprising: a monitor comprising: two or more tuners; a display for displaying video content from each of the two or more tuners; at least one speaker for producing audio corresponding to the display from one of the two or more tuners; and a wireless signal generation means for generating wireless audio signals corresponding to the display from another of the two or more tuners and for transmitting the wireless audio signals; and a base comprising: wireless signal receiving means for receiving the wireless audio signals from the wireless signal generation means and converting the wireless audio signals to audio signals; and a headphone connector operatively connected to the wireless signal receiving means for directing the audio signals to a headphones connected to the headphone connector.

Preferably, the monitor is a television. Preferably, the headphone connector is a female headphone jack disposed in the base. Preferably, the base is a remote control for use with the monitor.

Also provided is a remote control for a monitor. The remote control comprising: wireless signal receiving means for receiving wireless audio signals from the monitor and converting the wireless audio signals to audio signals; and a headphone connector operatively connected to the wireless signal receiving means for directing the audio signals to a headphones connected to the headphone connector.

Preferably, the headphone connector is a female headphone jack disposed in the remote control.

Still further provided is a method for allowing two or more viewers to simultaneously view and listen to different video content. The method comprising: displaying video content from each of two or more tuners on a monitor; producing audio corresponding to the display from one of the two or more tuners; generating wireless audio signals corresponding to the display from another of the two or more tuners; transmitting the wireless audio signals to a base; receiving the wireless audio signals at the base; and directing the audio signals to a headphones operatively connected to the base.

Preferably, the generating of the wireless audio signals is enabled upon the enabling of a picture-in-picture mode of the monitor. Preferably, the base is a remote control for use with the monitor.

Also provided are a computer program product for carrying out the methods of the present invention and a program storage device for the storage of the computer program product therein.

### BRIEF DESCRIPTION OF THE DRAWINGS

These and other features, aspects, and advantages of the apparatus and methods of the present invention will become better understood with regard to the following description, appended claims, and accompanying drawings where:

FIG. 1 illustrates a schematic of a preferred implementation of an apparatus of the present invention for allowing more than one user to simultaneously view and listen to more than one picture (video content) on a PIP capable television.

FIG. 2 illustrates a preferred implementation of an electrical schematic of the apparatus of FIG. 1.

### DETAILED DESCRIPTION OF THE PREFERRED EMBODIMENT

Although this invention is applicable to numerous and various types of monitors and video content, it has been found particularly useful in the environment of televisions and video content displayed thereon. Therefore, without limiting the applicability of the invention to televisions and video content displayed thereon, the invention will be described in such environment.

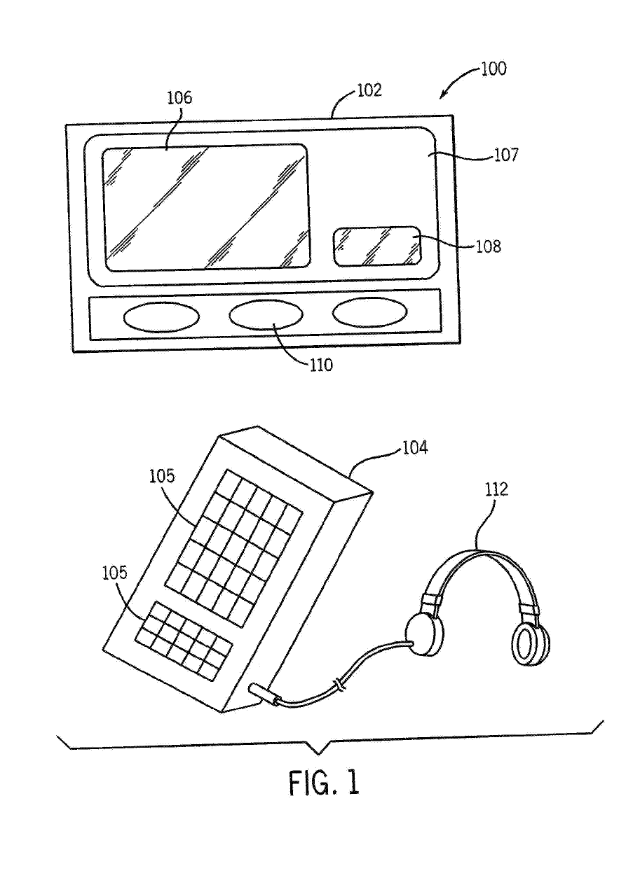

Referring now to FIG. 1, there is shown a preferred implementation of an apparatus for allowing two or more viewers to simultaneously view and listen to different video content displayed on a single monitor, the apparatus being generally referred to by reference numeral 100. The apparatus 100 comprises a monitor 102, such as a television, and a base unit 104 that is preferably a remote control 104 for use with the monitor 102. The base unit 104 can have no other function other than receiving wireless signals from the monitor 102 and delivering the same to headphones connected thereto or the base 104 can have other functions for use with the monitor 102, such as the remote control 102. The remote control 104 is preferably a wireless device which communicates with the monitor 102 through a wireless medium such as RF or infrared to control certain functions of the monitor 102, such as changing the channel, changing the volume, displaying a menu, traversing and selecting items in the menu for programming of certain features of the monitor 102, and for enabling/disabling a PIP function. The functions are selected by depressing one or more buttons 105 on the remote control 104 corresponding to the functions.

The monitor 102 generally has a PIP capability so as to be able to display at least first and second pictures (displays or picture displays) 106, 108 on a picture screen 107. As discussed above, the PIP may have one picture displayed inside a main picture or pictures displayed side-by-side. The pictures 106, 108 may be of the same size or one may be larger than the other. The monitor 102 also has at least one speaker 110, and preferably several speakers for producing stereo sound corresponding to an audio portion of one of the displayed pictures e.g., 106. As will be discussed in detail below, the remote control 104 further has headphones 112 operatively connected thereto for allowing a user to listen to an audio portion of another of the displayed pictures e.g., 108. The headphones 112 can be hardwired to the remote control 112 or preferably detachably connected thereto.

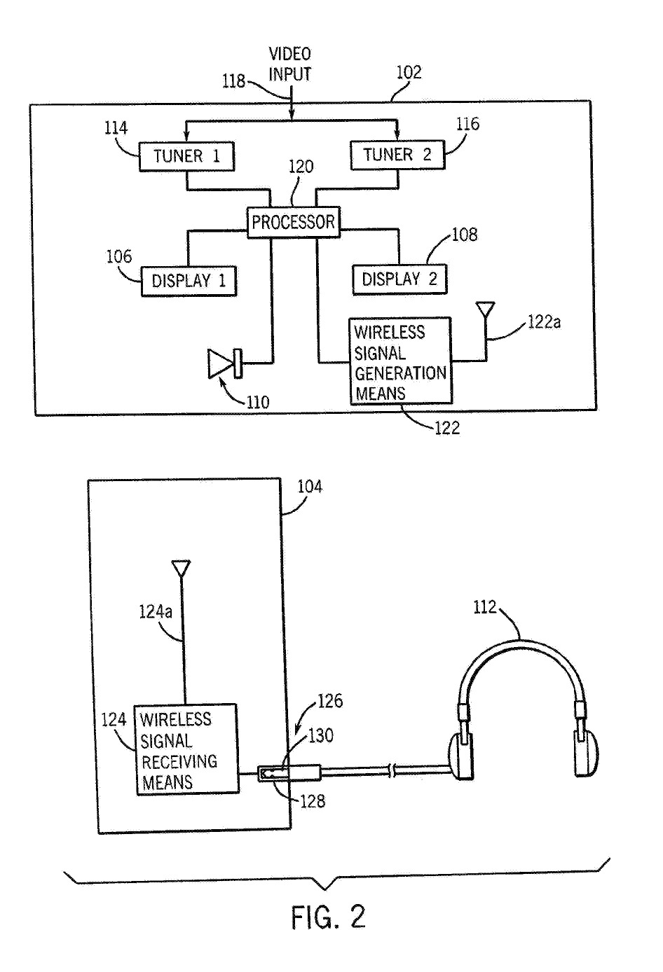

Referring now to FIG. 2, there is shown a preferred implementation of a schematic illustration of the apparatus of FIG. 1. The monitor 102 has first and second tuners 114, 116 for receiving a video input 118 which is split and received by each of the two tuners 114, 116. First and second tuners are shown by way of example only and not to limit the scope or spirit of the present invention. Those skilled in the art will appreciate that two or more such tuners can be provided in the monitor 102. The picture screen 107 of the monitor 102 is capable of displaying video content from each of the two or more tuners 114, 116 in any PIP format or configuration known in the art. Generally, the tuners 114, 116 and pictures 106, 108 (or display portions) are preferably under the control of a central processor 120 that not only controls the methods of the present invention but also controls the general functions and performance of the monitor 102.

As discussed above, the monitor 102 has at least one speaker 110, also under the control of the processor 120 for producing an audio portion corresponding to the display from one of the two or more tuners (tuner 1, 114 and display 1, 106 in FIG. 2). The monitor 102 further has a wireless signal generation means 122 for generating wireless audio signals corresponding to the display from another of the two or more tuners (tuner 2, 116 and display 2, 108 in FIG. 2) and for transmitting the wireless audio signals from the monitor 102 to the remote control 104. The wireless signal generation means 122 is not unlike that used in the prior art to generate and transmit wireless audio signals to a wireless headphone, and as such, a detailed description thereof is omitted for the sake of brevity. The wireless signal generation means 122 includes a transmitter 122a for transmitting the wireless audio signals from the monitor 102 to the remote control 104. While the wireless signal generation means 122 can always be functional, it preferably becomes operational, or enabled, upon the PIP function of the monitor 102 being enabled.

The remote control 104 comprises a wireless signal receiving means 124 for receiving the wireless audio signals from the wireless signal generation means 122 and converting the wireless audio signals to audio signals corresponding to the other of the picture displays (picture display 108 in FIG. 2). The wireless signal receiving means 124 includes an antenna 124a for receiving the wireless audio signals. The wireless signal receiving means 124 is not unlike that used in wireless headphones of the prior art to receive wireless audio signals, to conform such signals to audio signals useful with headphone speakers, and for delivering the audio signals to the headphone speakers to drive said speakers, and as such, a detailed description thereof is omitted for the sake of brevity.

The remote control 104 further has a headphone connector 126 operatively connected to the wireless signal receiving means 124 for directing the audio signals to the headphones connected to the headphone connector 126. Preferably, the headphone connector is a female headphone jack 128 disposed in the remote control 104. Although, a detachable connection between the remote control 104 and the headphones 112 is preferred, as discussed above, the headphones 112 may also be hardwired to the remote control 104. Since the headphones 112 are preferably detachable from the remote control 104, those skilled in the art will appreciate that relatively inexpensive headphones 112 having a mating male headphone jack 130 can be utilized, such as the headphones 112 used with Walkman radios and CD players. Those skilled in the art will also appreciate that the present invention allows two or more users to view and listen to different video content on a single monitor without using expensive wireless headphones or without the nuisance of being close to the monitor or the need for a long headphone extension.

The monitor 102 and remote control 104 are not shown with all of their components that are not necessary to an understanding of the present invention. However, such components necessary for the normal operation of the monitor 102 and remote control 104 are assumed to be present.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A television system for allowing two or more viewers to simultaneously view and listen to video content, the television system comprising:
a television monitor comprising:
a first tuner and a second tuner for receiving the video content;
a display for simultaneously displaying the video content from the first and second tuners, respectively;
at least one speaker hardwired to the television monitor for producing audio corresponding to the displayed video content from any of the first and second tuners; and
a wireless signal generator for generating wireless audio signals corresponding to the displayed video content from any other of the first and second tuners and for transmitting the wireless audio signals; and
a single remote control for controlling the television monitor, the remote control comprising:
a wireless signal receiver for receiving the wireless audio signals from the wireless signal generator;
a headphone connector operatively connected to the wireless signal receiver for directing the audio signals to headphones detachably connected to the headphone connector; and
a plurality of buttons for entering commands for controlling at least a changing of video content displayed on the display and changing of an audio volume corresponding to the displayed video content.

2. The apparatus of claim 1, wherein the headphone connector is a female headphone jack disposed in the single remote control.

3. The apparatus of claim 1, wherein the wireless signal generator generates the wireless audio signals in response to selection of a picture-in-picture function to display the video content from each of two or more tuners.

4. A method for enabling two or more viewers to simultaneously view and listen to different video content, the method comprising:
displaying simultaneously video content from each of two or more tuners on a television monitor;
producing with a speaker hardwired to the television monitor audio corresponding to the displayed video content from any of the two or more tuners;
generating wireless audio signals corresponding to the displayed video content from any other of the two or more tuners simultaneously with the at least one speaker producing the audio;
transmitting the wireless audio signals to a single remote control;
receiving the wireless audio signals at the single remote control;
directing the audio signals to headphones detachably connected to the remote control; and
entering commands on the single remote control for controlling at least a changing of video content displayed and changing of an audio volume corresponding to the displayed video content.

5. The method of claim 3, wherein the wireless audio signals are generated in response to an act of selecting the simultaneous display of the video content.

6. The method of claim 4, comprising enabling the wireless signal generator to generate the wireless audio signals in response to the television monitor being enabled to display the video content from each of two or more tuners.

7. A method for enabling two or more viewers to simultaneously view and listen to different video content, the method comprising acts of:
displaying video content simultaneous with picture-in-picture (PIP) video content on a television monitor;
producing with a speaker hardwired to the television monitor audio corresponding to any of the displayed video content;
controlling at least one of the primary and secondary video content with a wireless remote control; and
producing with headphones removably connected to the wireless remote control audio corresponding to any other of the displayed video content.

8. The method of claim 7, comprising acts of:
selecting the simultaneous display of the video content; and
transmitting the audio to the headphones in response to the selecting act.
